(19) United States
(12) Patent Application Publication
(10) Pub. No.: US 2016/0356915 A1
(43) Pub. Date: Dec. 8, 2016

(54) FOUR PLANE X-RAY INSPECTION SYSTEM

(71) Applicants: Christopher K. Green, Marietta, GA (US); Eric Weldon, Toccoa, GA (US); Marion I. Starns, IV, Atlanta, GA (US); Alfred Forbes, IV, Suwanee, GA (US)

(72) Inventors: Christopher K. Green, Marietta, GA (US); Eric Weldon, Toccoa, GA (US); Marion I. Starns, IV, Atlanta, GA (US); Alfred Forbes, IV, Suwanee, GA (US)

(21) Appl. No.: 15/139,972

(22) Filed: Apr. 27, 2016

Related U.S. Application Data
(60) Provisional application No. 62/153,427, filed on Apr. 27, 2015.

(51) Int. Cl. G01V 5/00

(52) U.S. Cl. CPC G01V 5/0041

(57) ABSTRACT

The present disclosure describes a four plane x-ray inspection system for inspecting objects present within containers to be transported and for identifying and distinguishing objects constituting weapons, explosives, bombs, materials, chemicals, drugs, substances, and other items that may cause harm to humans, vehicles, and property. The system uses four, multi-energy level, x-ray scanning planes, including two, multi-energy level, x-ray scanning planes configured at angles, in a scanning tunnel to generate ultra-high definition imaging data and metadata corresponding to dimensionally accurate front, top and side orthogonal views of a target object that may comprise a threat. The system also provides orthogonal views of such target objects and identifies them through the calculation of accurate effective atomic numbers and densities. Through use of the angled, multi-energy level, x-ray scanning planes, the system increases the probability of detecting threats while reducing the probability of false alarms.

### FIELD OF THE INVENTION

The present invention relates, generally, to the field of systems, including apparatuses and methods, for inspecting objects present within containers and for identifying and distinguishing objects constituting weapons, explosives, bombs, materials, chemicals, drugs, substances, and other items that may cause harm to humans, vehicles, and property.

### BACKGROUND OF THE INVENTION

Over the past twenty years or so, terrorism has spread throughout the world with thousands of people being killed or injured and significant property damage occurring as a result of bombs and other explosive devices blowing up on aircraft and in or near buildings. Governments have sought to combat and minimize the risks created by such bombs and other explosive devices by trying to detect and stop them from entering aircraft and buildings. A variety of methods have been employed in connection with detection efforts, including the use of bomb sniffing dogs and the use of baggage inspection systems. While the use of bomb sniffing dogs has been very successful, the number of dogs that are trained, capable, and available for duty in airports and buildings is limited due to the time required and costs associated with training such dogs. And, terrorists have become increasingly clever in attempting to hide and disguise the smell of explosives from such dogs, thereby making a dog's detection of bombs and explosive devices in baggage less likely.

As an alternative to the use of specially trained dogs, baggage inspection systems have been positioned at security checkpoints in airport corridors and entrances to buildings. Typically, such baggage inspection systems utilize x-rays emitted and configured in two plane, non-orthogonal architectures to scan and inspect baggage moved through an inspection tunnel on a conveyor belt. Data collected during exposure of the baggage to the x-rays is used to derive two basic signatures that are, in turn, used to discriminate amongst and identify materials present in the contents of the baggage. The signatures include (i) an effective atomic number and (ii) density. Unfortunately, such baggage inspection systems have failed to achieve desired probably of detection and probability of false alarm rates because of inherent cross-sectional prediction errors resulting in inaccurate effective atomic number and density calculations. Additionally, the “L” shaped detector arrays often used in two plane architectures create tunnel blind spots and large source-to-detector distance variances yielding limited dynamic range, inaccurate belt-level effective atomic number and density predictions, and high zone variations. In addition, images created from the collected data are, generally, limited to one or two views, thereby enabling bombs and other explosive devices to be hidden from an operator's view and, hence, from visible detection by clutter and other objects placed in the baggage.

Therefore, there is a need within the industry for an x-ray inspection system that produces accurate effective atomic number and density calculations for objects present in baggage, eliminates blind spots, and that solves these and other problems, difficulties, and shortcomings of existing systems.

### SUMMARY OF THE INVENTION

Broadly described, the present invention comprises a four plane x-ray inspection system, including apparatuses and methods, for inspecting and identifying objects in baggage, luggage, or other containers constituting weapons, explosives, bombs, materials, chemicals, drugs, substances, and other items that may cause harm to humans, vehicles, and property. According to an example embodiment, the four plane x-ray inspection system comprises a four plane x-ray scanning subsystem that generates ultra-high definition imaging data and metadata corresponding to dimensionally accurate front, top and side orthogonal views of a target object that may comprise a threat. The four plane x-ray scanning subsystem includes a four plane x-ray scanning tunnel having four, multi-energy level, x-ray scanning planes and corresponding multi-energy level x-ray sources and detector arrays, and a conveyor operable to move objects and containers holding objects from the scanning tunnel's entrance opening, through the four, multi-energy level, x-ray scanning planes in a direction parallel to the scanning tunnel's longitudinal axis, and to the scanning tunnel's exit opening. The four, multi-energy level, x-ray scanning planes comprise a top, multi-energy level, x-ray scanning plane extending solely in a direction perpendicular to the scanning tunnel's longitudinal axis, a side, multi-energy level, x-ray scanning plane extending solely in a direction perpendicular to the scanning tunnel's longitudinal axis, and two angled, multi-energy level, x-ray scanning planes each extending in a direction having components perpendicular and parallel to the scanning tunnel's longitudinal axis. Each of the two angled, multi-energy level, x-ray scanning planes defines an angle relative to the scanning tunnel's longitudinal axis (and, hence, to the conveyor's belt) having an angular measure in the range between thirty degrees (30°) and sixty degrees (60°). The first angled, multi-energy level, x-ray scanning plane extends in a direction generally toward the conveyor's belt and toward the scanning tunnel's exit opening. The second angled, multi-energy level, x-ray scanning plane extends in a direction generally toward the conveyor's belt and toward the scanning tunnel's entrance opening.

Also according to the example embodiment, the four plane x-ray inspection system further comprises a control subsystem, an operator interface subsystem, and a data management and processing subsystem. The control subsystem is configured and operable to orchestrate operation of the entire four plane x-ray inspection system, including operation of the four plane x-ray scanning subsystem. The operator interface subsystem is adapted and operable to allow a system operator to select or provide inputs, to display images of a container's contents, and to display information identifying and associated with identified threats. The data management and processing subsystem is configured and operable to produce orthogonal images of a container's contents, to discriminate and identify the materials present in threats or objects of interest, and to communicate data corresponding to the orthogonal images and identifying materials back to the operator interface subsystem for display to the system operator.

Advantageously, the four plane x-ray inspection system's four plane configuration allows the system to collect the data necessary, and enables the system to, identify and depict threats and objects of interest in low to high clutter environments (including, but not limited to, concealed threats) in real time with no blind spots and provide orthogonal views of such threats and objects of interest in a manner similar to that of a computer aided design (CAD) drawing. Also, using the collected data, the system interrogates objects of interest (such as, but not limited to, possible threats) and identifies them through the calculation of accurate effective atomic numbers and densities. Additionally, as a result of the collection of data from four x-ray planes and improved image generation, the system increases the probably of detection of threats and reduces the probability of false alarms.

Other uses and benefits of the present invention may become apparent upon reading and understanding the present specification when taken in conjunction with the appended drawings.

### BRIEF DESCRIPTION OF THE DRAWINGS

FIG. 1 displays a block diagram representation of a four plane x-ray inspection system in accordance with an example embodiment of the present invention.

FIG. 2 displays a cut-away, perspective, pictorial view of the four plane x-ray inspection system of FIG. 1 in which a four plane x-ray scanning tunnel having four, multi-energy, x-ray scanning planes and corresponding, multi-energy, x-ray sources and detector arrays are shown.

FIG. 3 displays a partial, side, schematic view of the four plane x-ray inspection system of FIG. 1 in which the four plane x-ray scanning tunnel, four, multi-energy, x-ray scanning planes, and corresponding, multi-energy, x-ray sources and detector arrays of FIG. 2 are shown.

FIG. 4 displays a cut-away, perspective, pictorial view of the four plane x-ray inspection system of FIG. 1 in which the four plane x-ray scanning tunnel, the first and second angled, multi-energy, x-ray scanning planes, and corresponding, multi-energy, x-ray sources and detector arrays are shown without the top and side x-ray scanning planes being visible.

FIG. 5 displays a partial, elevational, schematic view of the four plane x-ray inspection system of FIG. 1 looking from the entrance and toward the exit of the four plane x-ray scanning tunnel and in which the first angled, multi-energy, x-ray source, multi-energy, x-ray scanning plane, and detector array are shown.

FIG. 6 displays a partial, elevational, schematic view of the four plane x-ray inspection system of FIG. 1 looking from the entrance and toward the exit of the four plane x-ray scanning tunnel and in which the second angled, multi-energy, x-ray source, multi-energy, x-ray scanning plane, and detector array are shown.

FIG. 7 displays a cut-away, perspective, pictorial view of the four plane x-ray inspection system of FIG. 1 in which the four plane x-ray scanning tunnel, the top, multi-energy, x-ray scanning plane and corresponding, multi-energy, x-ray source and detector array are shown without the first and second angled, multi-energy, x-ray scanning planes and side, multi-energy, x-ray scanning planes being visible.

FIG. 8 displays a partial, elevational, schematic view of the four plane x-ray inspection system of FIG. 1 looking from the entrance and toward the exit of the four plane x-ray scanning tunnel and in which the top, multi-energy, x-ray source, multi-energy, x-ray scanning plane, and detector array are shown.

FIG. 9 displays a cut-away, perspective, pictorial view of the four plane x-ray inspection system of FIG. 1 in which the four plane x-ray scanning tunnel, the side, multi-energy, x-ray scanning plane and corresponding, multi-energy, x-ray source and detector array are shown without the first and second angled, multi-energy, x-ray scanning planes and top, multi-energy, x-ray scanning plane being visible.

FIG. 10 displays a partial, elevational, schematic view of the four plane x-ray inspection system of FIG. 1 looking from the entrance and toward the exit of the four plane x-ray scanning tunnel and in which the side, multi-energy, x-ray source, multi-energy, x-ray scanning plane, and detector array are shown.

### DETAILED DESCRIPTION OF THE DRAWINGS

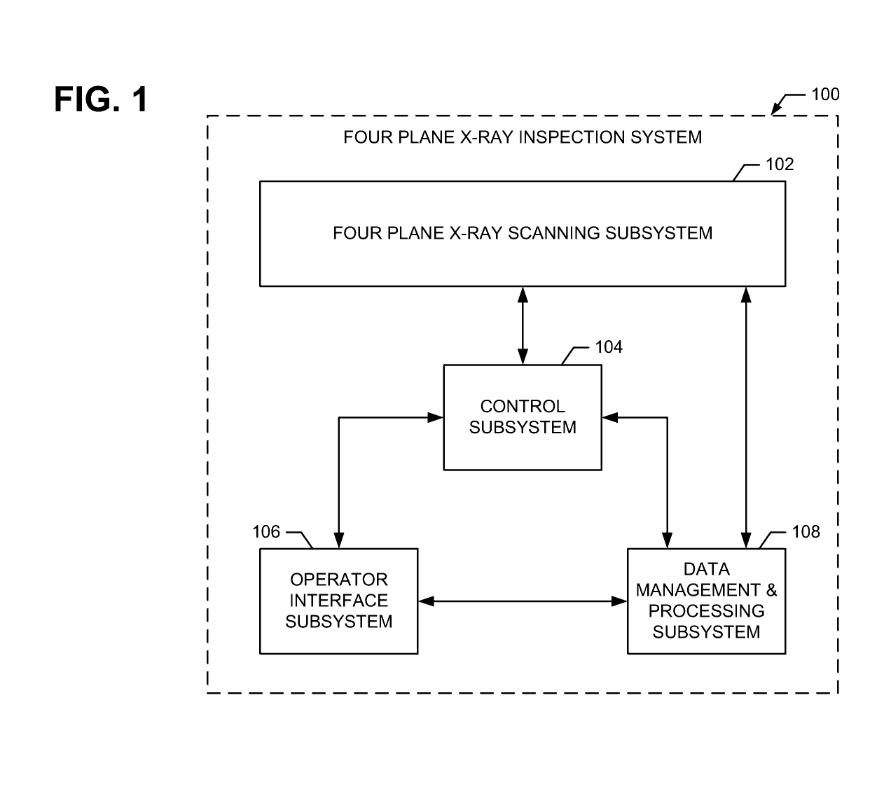

Referring now to the drawings in which like numerals represent like elements or steps throughout the several views, FIG. 1 displays a block diagram representation of a four plane x-ray inspection system 100 in accordance with an example embodiment. The four plane x-ray inspection system 100 (also sometimes referred to herein as the “system 100”) of the example embodiment uses four, multi-energy level, x-ray scanning planes 112 to scan objects and containers holding objects that are introduced into the system 100 and identify objects comprising weapons, explosives, bombs, materials, chemicals, drugs, substances, and other items that may cause harm to humans, vehicles, and property (such harmful objects being sometimes, collectively, referred to herein as “threats”). As used herein, the term “container” includes, without limitation, luggage, suitcases, bags, boxes, crates, and similar items used to transport clothing, personal belongings, and other objects. The term “vehicle”, as used herein, includes aircraft, watercraft, railed vehicles (including, but not limited to, trains and trams), motor vehicles (including, without limitation, cars, trucks, motorcycles, and buses), and spacecraft. When configured as in the example embodiment described herein, the four plane x-ray inspection system 100 may be used to inspect, generally, smaller objects and containers holding other objects that are to be transported, for instance, by a vehicle as part of a passenger's personal belongings and to identify any threats. When similarly configured on a larger scale in other embodiments, the term “container” also includes, without limitation, the shipping containers, rail cars, vehicles and truck trailers themselves, and the four plane x-ray inspection system 100 may be used to inspect such shipping containers, rail cars, vehicles and truck trailers together with objects present therein and to identify any objects constituting threats.

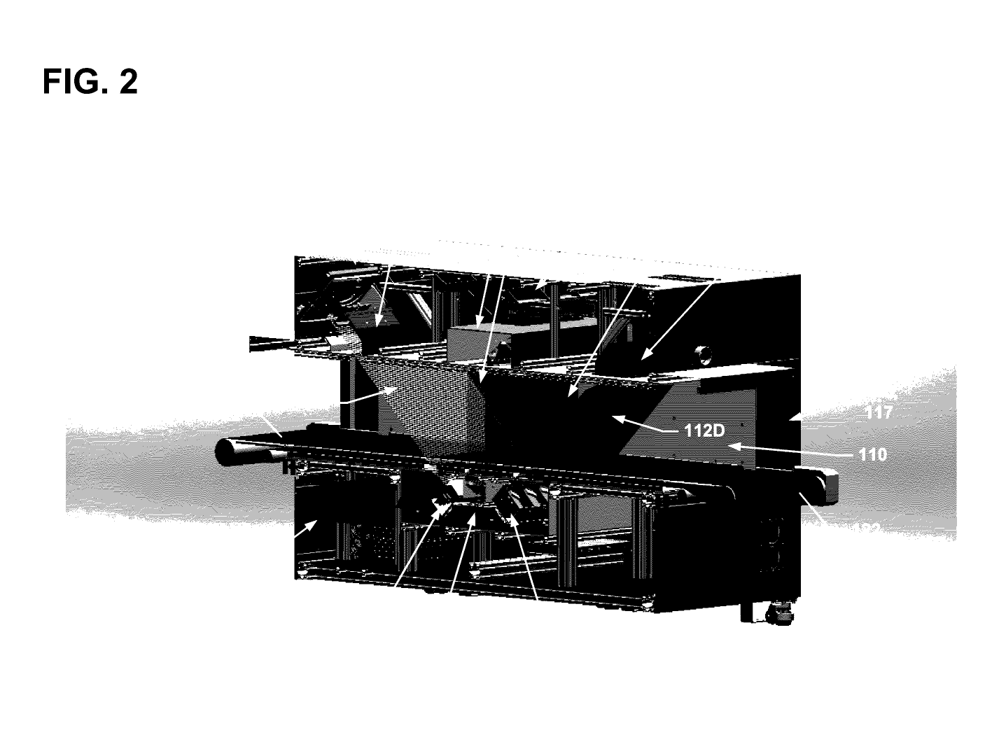

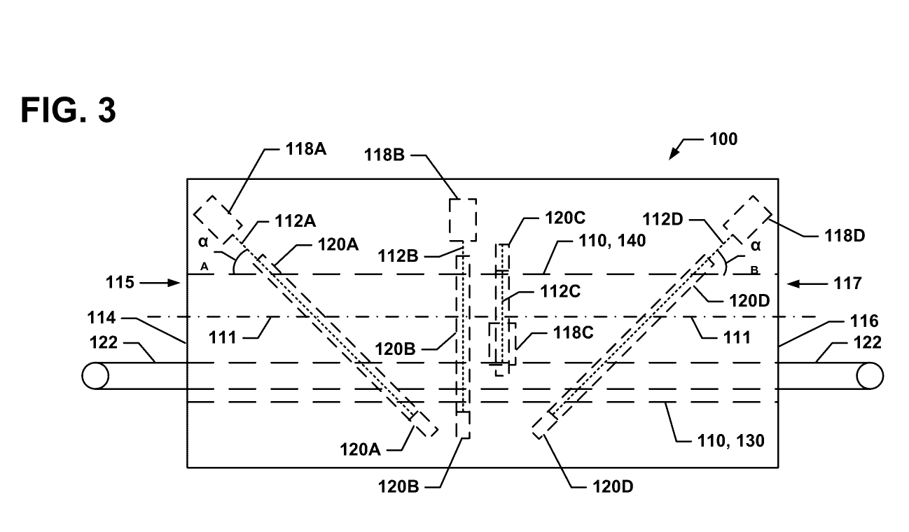

The four plane x-ray inspection system 100 comprises a four plane x-ray scanning subsystem 102, a control subsystem 104, an operator interface subsystem 106, and a data management and processing subsystem 108. The four plane x-ray scanning subsystem 102, described in more detail below, comprises a four plane x-ray scanning tunnel 110 (also sometimes referred to herein as the “scanning tunnel 110”) through which objects and containers holding objects move. The four plane x-ray scanning subsystem 102 produces and utilizes four independent, multi-energy level, x-ray scanning planes 112A, 112B, 112C, 112D (see FIGS. 2 and 3) to provide full scanning tunnel 110 coverage in a configuration that yields ultra-high definition imaging and metadata corresponding to dimensionally accurate front, top and side views of a target object that may comprise a threat. The multi-energy level, x-ray scanning planes 112 include a top, multi-energy level, x-ray scanning plane 112B, a side, multi-energy level, x-ray scanning plane 112C, and two angled, multi-energy level, x-ray scanning planes 112A, 112D that traverse the scanning tunnel 110 respectively emulating x-ray beams fired into the tunnel's entrance opening 114 and exit opening 116. The angled, multi-energy level, x-ray scanning planes 112A, 112D enable the system 100 to generate the side view of a target object. The system's four plane configuration allows the system 100 to collect the data necessary, and enables the system 100 to, identify and depict objects of interest in low to high clutter environments in real time and provide orthogonal views of objects of interest in a manner similar to that of a computer aided design (CAD) drawing. Using the collected data, the system 100 interrogates objects of interest (such as, but not limited to, possible threats) and identifies them through material discrimination methods.

The system's control subsystem 104 includes hardware and software that controls operation of the four plane x-ray scanning subsystem 102 (including, but not limited to, the generation of the four independent, multi-energy level, x-ray scanning planes 112A, 112B, 112C, 112D by the subsystem's four respective, multi-energy level, x-ray sources 118A, 118B, 118C, 118D and the collection of data from the subsystem's four respective detector arrays 120A, 120B, 120C, 120D) and interacts with the operator interface subsystem 106 to receive system operator inputs and to provide output information to the operator interface subsystem 106. The control subsystem 104 also interacts with the data management and processing subsystem 108 to orchestrate the delivery of data collected by the four plane x-ray scanning subsystem 102 to the data management and processing subsystem 108 for subsequent processing.

The operator interface subsystem 106 includes user interface hardware and software that allows a system operator to select or provide inputs for user-configurable system options that configure how the system 100 will operate. The operator interface subsystem 106 delivers such inputs and/or signals or instructions based on such inputs, to the system's control subsystem 104 and data management and processing subsystem 108, as appropriate, to configure or direct their operation. Also, the operator interface subsystem 106 receives output information and data from the system's data management and processing subsystem 108 corresponding to images of a container's contents for display via a display device of the subsystem 106 and that identifies possible threats or objects of interest for further investigation. Upon receiving input from a system operator selecting a threat or object of interest for further investigation and communicating such selection to the system's data management and processing subsystem 108, the operator interface subsystem 106 receives information and data from the system's data management and processing subsystem 108 identifying potentially harmful materials present in such threat or object of interest and displays such information and data to the system operator.

The system's data management and processing subsystem 108 comprises hardware and software that receive data from the four plane x-ray scanning subsystem 102 (including, without limitation, from the subsystem's four detector arrays 120A, 120B, 120C, 120D) as an object or a container including one or more objects passes, respectively, through the four, multi-energy level, x-ray scanning planes 112A, 112B, 112C, 112D. The data management and processing subsystem 108 is configured with computer hardware and software to manage and process the received data in real time, to produce image data corresponding to the objects present, to generate data identifying possible threats, and to communicate such image and threat related data to the system's operator interface subsystem 106 for display to a system operator. The data management and processing subsystem 108 is also configured to receive input from a system operator via the operator interface subsystem 106 identifying threats or objects of interest for further investigation, to discriminate and identify the materials present in the such threats or objects of interest using data collected and associated with each energy level of the multi-energy level x-ray beams 126, and to communicate data identifying such materials back to the operator interface subsystem 106 for display to the system operator.

FIG. 2 displays the four plane x-ray inspection system 100 and certain components of its subsystems 102, 104, 106, 108 in pictorial form. As seen in FIG. 2, the four plane x-ray scanning subsystem 102 comprises a scanning tunnel 110 having an entrance opening 114 at a first end 115 and a longitudinally opposed exit opening 116 at a second end 117. The scanning tunnel 110 defines a longitudinal axis 111 extending between the first and second ends 115, 117. A conveyor 122 extends within the scanning tunnel 110 and through the tunnel's entrance opening 114 and exit opening 116, and is operable to move objects or containers of objects introduced at the tunnel's entrance opening 114 through the scanning tunnel 110 in the direction of longitudinal axis 111 and out of the scanning tunnel 110 at its exit opening 116.

As described briefly above, the four plane x-ray scanning subsystem 102 comprises four, independent, multi-energy level, x-ray sources 118A, 118B, 118C, 118D that are configured to generate, during the system's operation, four corresponding independent, multi-energy level, x-ray scanning planes 112A, 112B, 112C, 112D such that each object or container of objects travels along the conveyor 122 and through each of the four, multi-energy level, x-ray scanning planes 112A, 112B, 112C, 112D. The four plane x-ray scanning subsystem 102 also comprises four independent detector arrays 120A, 120B, 120C, 120D that are associated in one-to-one correspondence with the four independent, multi-energy level, x-ray sources 118A, 118B, 118C, 118D and four independent, multi-energy level, x-ray scanning planes 112A, 112B, 112C, 112D. During operation, each detector array 120 receives a portion of the multi-energy level, x-ray beam 126 emitted by its corresponding multi-energy level, x-ray source 118 and produces signals and/or data corresponding to the received portion of the multi-energy level, x-ray beam 126 that are output to the data management and processing subsystem 108 for the generation of images and threat identifications.

The four, multi-energy level, x-ray scanning planes 112A, 112B, 112C, 112D, as described briefly above, include a first angled, multi-energy level, x-ray scanning plane 112A, a top, multi-energy level, x-ray scanning plane 112B, a side, multi-energy level, x-ray scanning plane 112C, and a second angled, multi-energy level, x-ray scanning plane 112D. The first angled, multi-energy level, x-ray scanning plane 112A is located near the scanning tunnel's entrance 114 and is the first, multi-energy level, x-ray scanning plane 112 encountered by an object or container of objects introduced into the scanning tunnel 110. The first angled, multi-energy level, x-ray scanning plane 112A extends downward toward the conveyor 122 and toward the scanning tunnel's exit opening 116 from its corresponding multi-energy level, x-ray source 118A while defining an angle, α_{A}, relative to longitudinal axis 111. According to the example embodiment, the angle, α_{A}, has an angular measure in the range between thirty degrees (30°) and sixty degrees (60°) with a measure of forty-five degrees (45°) perhaps being optimum and yielding the best results. The top, multi-energy level, x-ray scanning plane 112B is the second, multi-energy level, x-ray scanning plane 112 encountered by an object or container of objects introduced into the scanning tunnel 110 and extends downward toward the conveyor 122 from its corresponding multi-energy level, x-ray source 118B such that the top, multi-energy level, x-ray scanning plane 112B is perpendicular to longitudinal axis 111. The side, multi-energy level, x-ray scanning plane 112C is the third, multi-energy level, x-ray scanning plane 112 encountered by an object or container of objects introduced into the scanning tunnel 110 and extends laterally across the conveyor 122 from its corresponding multi-energy level, x-ray source 118C such that the side, multi-energy level, x-ray scanning plane 112C is perpendicular to longitudinal axis 111. The second angled, multi-energy level, x-ray scanning plane 112D is located near the scanning tunnel's exit 116 and is the fourth, and last, multi-energy level, x-ray scanning plane 112 encountered by an object or container of objects introduced into the scanning tunnel 110. The second angled, multi-energy level, x-ray scanning plane 112D extends downward toward the conveyor 122 and toward the scanning tunnel's entrance opening 114 from its corresponding multi-energy level, x-ray source 118D while defining an angle, α_{B}, relative to longitudinal axis 111. According to the example embodiment, the angle, α_{B}, has an angular measure in the range between thirty degrees (30°) and sixty degrees (60°) with a measure of forty-five degrees (45°) perhaps being optimum and yielding the best results.

It should be understood and appreciated that while each multi-energy level, x-ray scanning plane 112 extends generally in the respective directions and angles described above, each multi-energy level, x-ray scanning plane 112 spreads sufficiently to cover the entire lateral cross-section of the scanning tunnel 110 so that all objects or containers of objects (and all portions of all objects or containers of objects) are scanned, regardless of their lateral or elevational positions relative to the conveyor 122 and within the scanning tunnel 110. It should also be understood and appreciated that angle, α_{A}, and angle, α_{B}, may have the same angular measure or may each have a different angular measure.

The orientation of the multi-energy level, x-ray scanning planes 112A, 112B, 112C, 112D and their respective multi-energy level, x-ray sources 118A, 118B, 118C, 118D and detector arrays 120A, 120B, 120C, 120D is more clearly seen in the side, schematic view of FIG. 3. In FIG. 3, the first and second angled, multi-energy level, x-ray scanning planes 112A, 112D are visible forming their respective angles, α_{A} and α_{B}, with longitudinal axis 111. The top, multi-energy level, x-ray scanning plane 112B is visible extending generally downward and perpendicular to longitudinal axis 111. The side, multi-energy level, x-ray scanning plane 112C is visible extending generally laterally across the conveyor 122 in the direction of the conveyor's width and perpendicular to longitudinal axis 111.

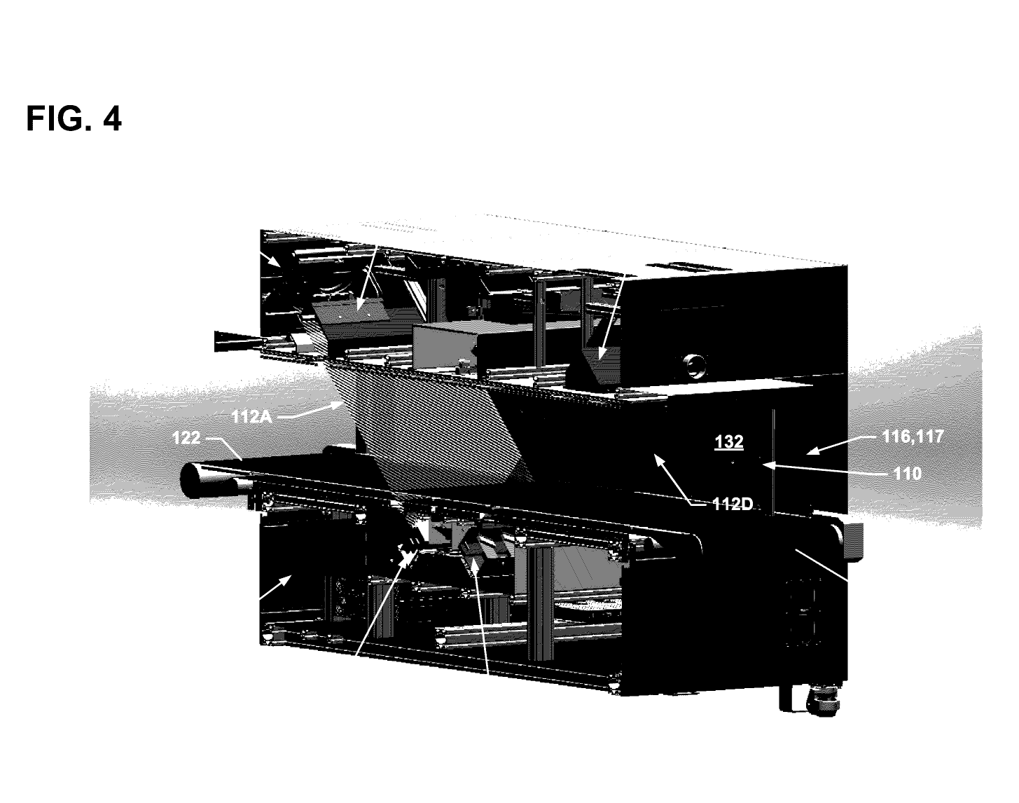

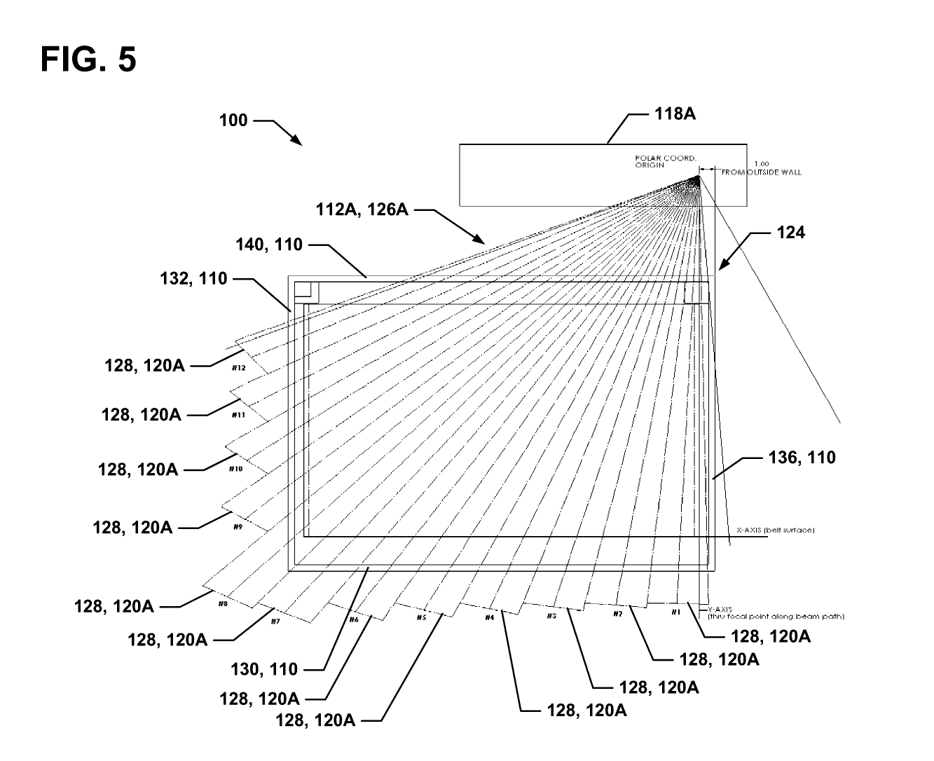

FIGS. 4-6 display the first and second angled, multi-energy level, x-ray scanning planes 112A, 112D and illustrate the relative locations of the corresponding multi-energy level, x-ray sources 118A, 118D and detector arrays 120A, 120D associated with the first and second angled, multi-energy level, x-ray scanning planes 112A, 112D and the coverage of the scanning tunnel's cross-section provided by the angled, multi-energy level, x-ray scanning planes 112A, 112D. As illustrated in FIG. 5, the multi-energy level, x-ray source 118A for the first angled, multi-energy level, x-ray scanning plane 112A is located near the upper front corner 124 of the scanning tunnel's cross-section as viewed from the scanning tunnel's entrance opening 114. The multi-energy level, x-ray source 118A generates a multi-energy level x-ray beam 126A that forms the corresponding first angled, multi-energy level, x-ray scanning plane 112A. The multi-energy level, x-ray beam 126A comprises a generally fan-shaped beam that covers the entire scanning tunnel cross-section. The x-ray detector array 120A comprises a plurality of x-ray detectors 128 forming a generally “L” shape with some of the x-ray detectors 128 being located near the scanning tunnel's bottom panel 130 and others located near the scanning tunnel's back panel 132. Each x-ray detector 128 of the x-ray detector array 120A is mounted to be substantially perpendicular to the portion of the multi-energy level, x-ray beam 126A striking the x-ray detector 128.

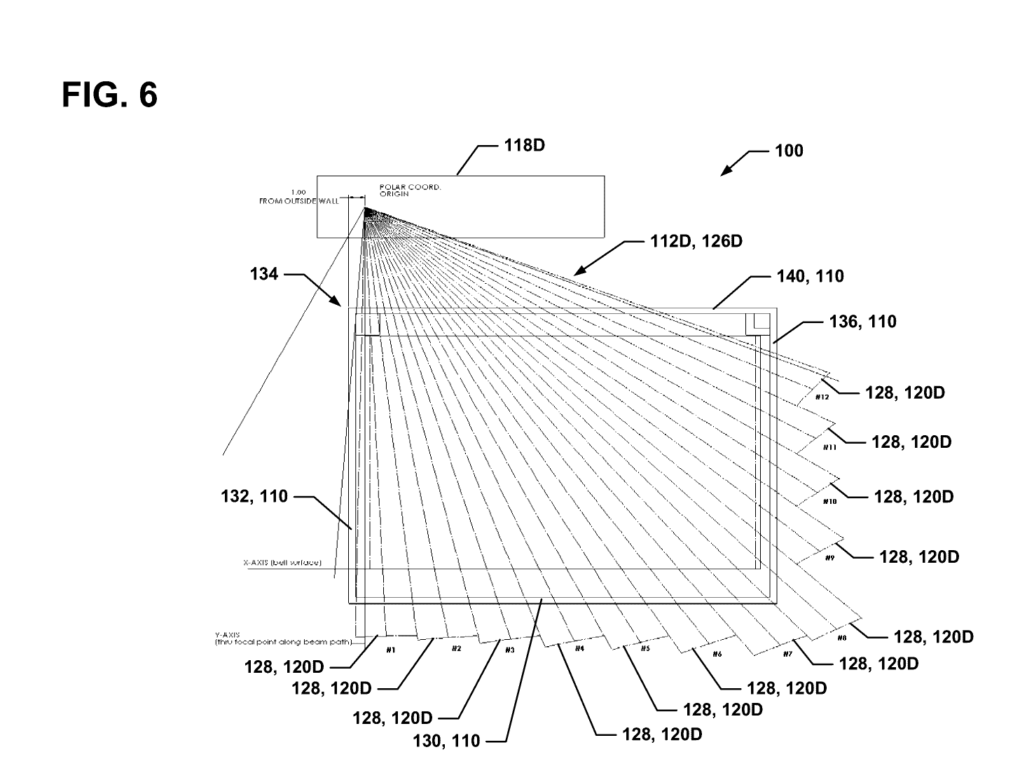

As illustrated in FIG. 6, the multi-energy level, x-ray source 118D for the second angled, multi-energy level, x-ray scanning plane 112D is located near the upper back corner 134 of the scanning tunnel's cross-section as viewed from the scanning tunnel's entrance opening 114. The multi-energy level, x-ray source 118D generates a multi-energy level, x-ray beam 126D that forms the corresponding second angled, multi-energy level, x-ray scanning plane 112D. The multi-energy level, x-ray beam 126D comprises a generally fan-shaped beam that covers the entire scanning tunnel cross-section. The x-ray detector array 120D comprises a plurality of x-ray detectors 128 forming a generally “L” shape with some of the x-ray detectors 128 being located near the scanning tunnel's bottom panel 130 and others located near the scanning tunnel's front panel 136. Each x-ray detector 128 of the x-ray detector array 120D is mounted to be substantially perpendicular to the portion of the multi-energy level, x-ray beam 126A striking the x-ray detector 128.

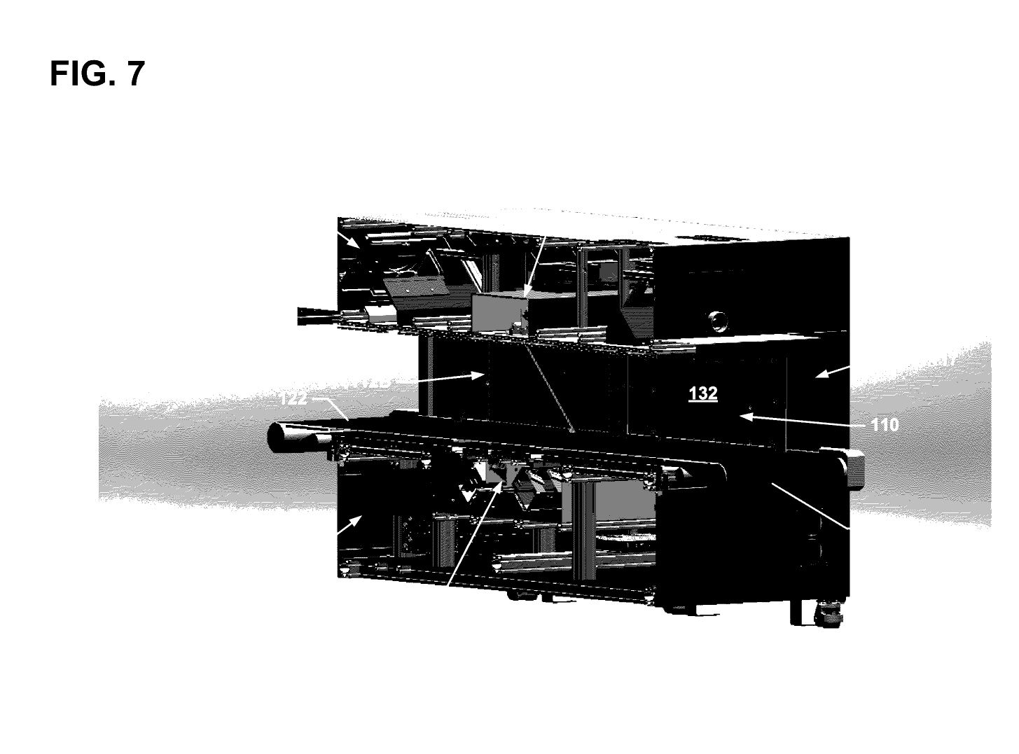

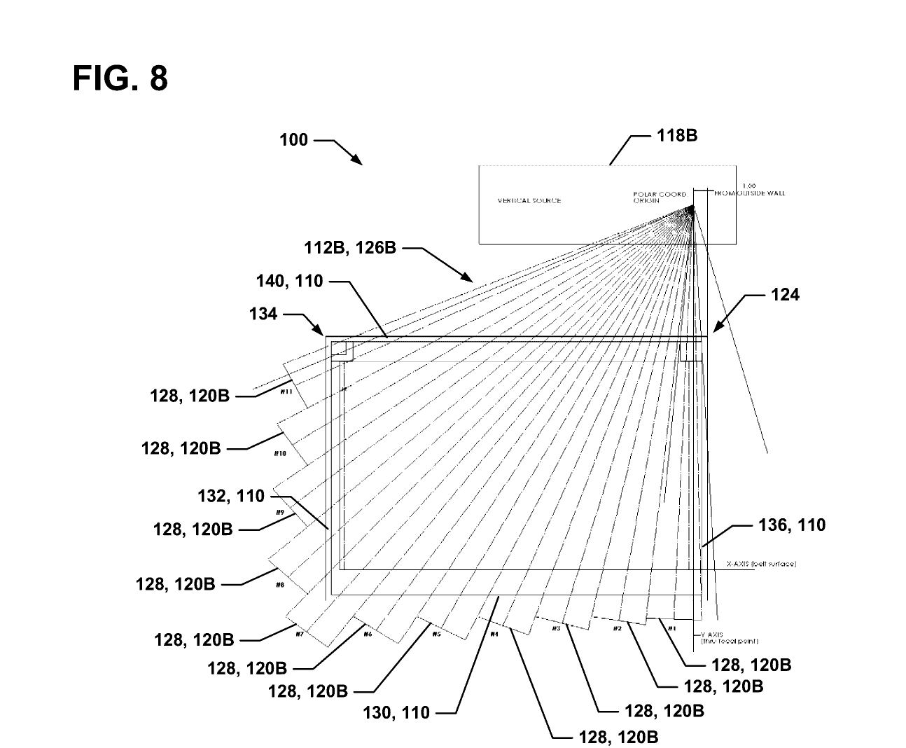

FIGS. 7-8 display the top, multi-energy level, x-ray scanning plane 112B and illustrate the relative locations of the corresponding multi-energy level, x-ray source 118B and detector array 120B associated with the top, multi-energy level, x-ray scanning plane 112B and the coverage of the scanning tunnel's cross-section provided by the top, multi-energy level, x-ray scanning plane 112B. As illustrated in FIG. 8, the multi-energy level, x-ray source 118B for the top, multi-energy level, x-ray scanning plane 112B is located near the upper front corner 124 of the scanning tunnel's cross-section as viewed from the scanning tunnel's entrance opening 114. The multi-energy level, x-ray source 118B generates a multi-energy level, x-ray beam 126B that forms the corresponding top, multi-energy level, x-ray scanning plane 112B. The multi-energy level, x-ray beam 126B comprises a generally fan-shaped beam that covers the entire scanning tunnel cross-section. The x-ray detector array 120B comprises a plurality of x-ray detectors 128 forming a generally “L” shape with some of the x-ray detectors 128 being located near the scanning tunnel's bottom panel 130 and others located near the scanning tunnel's back panel 132. Each x-ray detector 128 of the x-ray detector array 120B is mounted to be substantially perpendicular to the portion of the x-ray beam 126B striking the x-ray detector 128.

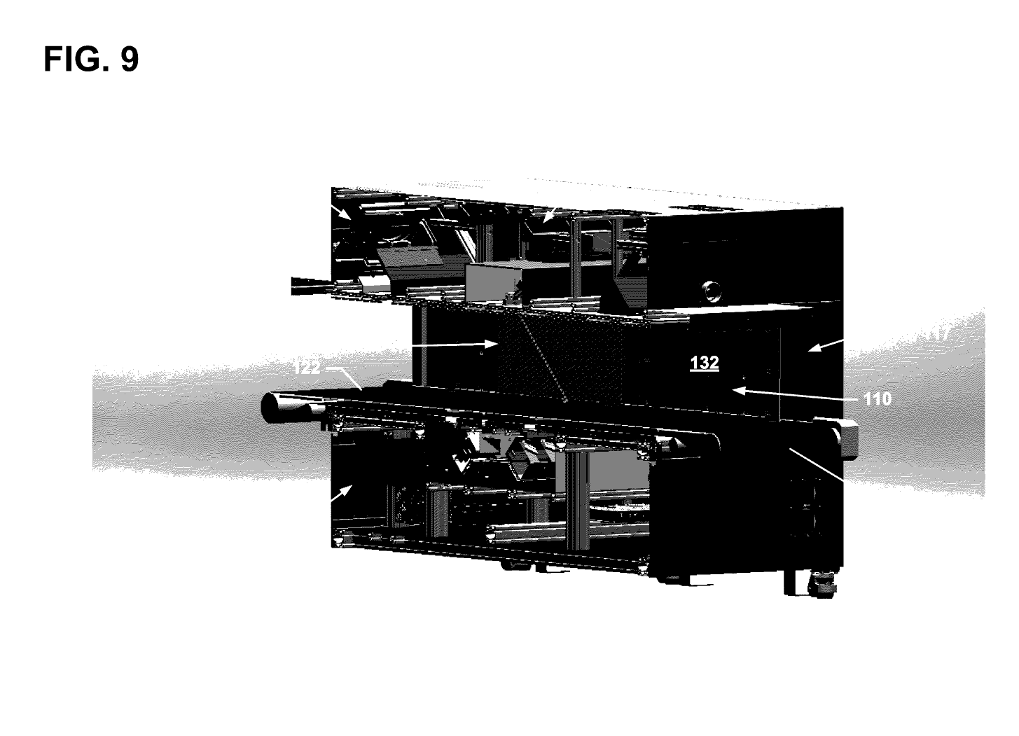

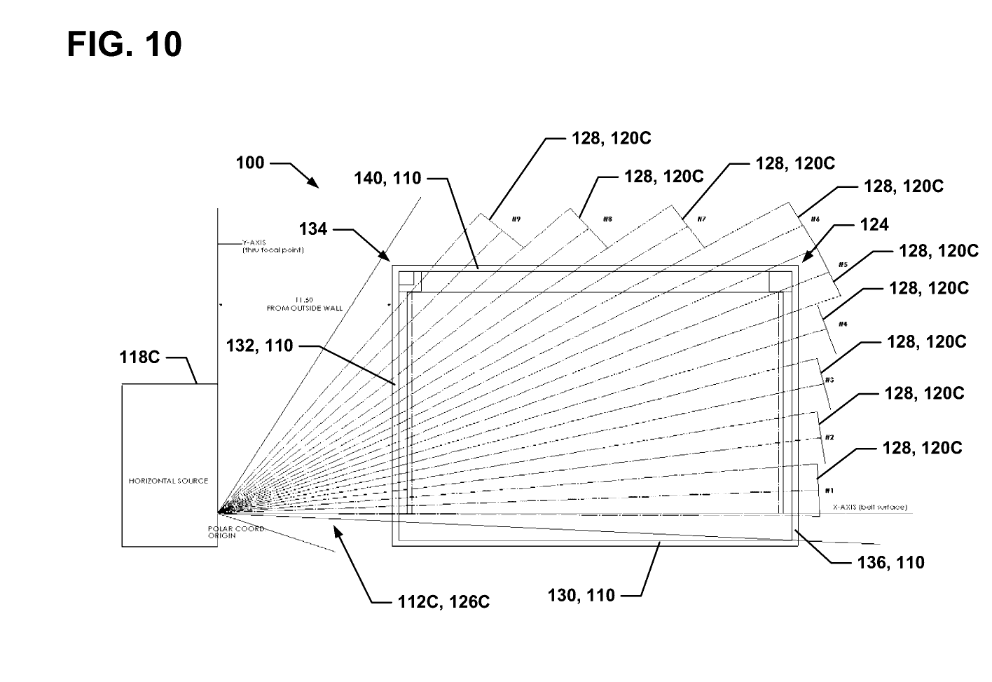

FIGS. 9-10 display the side, multi-energy level, x-ray scanning plane 112C and illustrate the relative locations of the corresponding multi-energy level, x-ray source 118C (not visible) and detector array 120C associated with the side, multi-energy level, x-ray scanning plane 112C and the coverage of the scanning tunnel's cross-section provided by the side, multi-energy level, x-ray scanning plane 112C. As illustrated in FIG. 10, the multi-energy level, x-ray source 118C for the top, multi-energy level, x-ray scanning plane 112C is located near the lower back corner 138 of the scanning tunnel's cross-section as viewed from the scanning tunnel's entrance 114. The multi-energy level, x-ray source 118C generates a multi-energy level, x-ray beam 126C that forms the corresponding side, multi-energy level, x-ray scanning plane 112C. The multi-energy level, x-ray beam 126C comprises a generally fan-shaped beam that covers the entire scanning tunnel cross-section. The x-ray detector array 120C comprises a plurality of x-ray detectors 128 forming a generally “L” shape with some of the x-ray detectors 128 being located near the scanning tunnel's front panel 136 and others located near the scanning tunnel's top panel 140. Each x-ray detector 128 of the x-ray detector array 120B is mounted to be substantially perpendicular to the portion of the multi-energy level, x-ray beam 126B striking the x-ray detector 128.

It should be understood and appreciated that the locations of the x-ray sources 118 and detector arrays 120 may be different in other embodiments of the four plane x-ray inspection system 100. For example, the location of multi-energy level, x-ray source 118B may be centered above the scanning tunnel's top panel 140 between the tunnel's front and back panels 136, 132. Also, the order in which the multi-energy level, x-ray scanning planes 112 are encountered by an object or container of objects traveling through the scanning tunnel 110 may be different in other embodiments of the four plane x-ray inspection system 100. Additionally, if imaging of objects is desired without material discrimination, the multi-energy level, x-ray sources 118 may be configured to generate single-energy level, x-ray beams 126.

Whereas the present invention has been described in detail above with respect to an example embodiment thereof, it should be appreciated that variations and modifications might be effected within the spirit and scope of the present invention.

What is claimed is:

1. An apparatus for scanning a container holding objects therein to be transported and for identifying any object in the container constituting a threat, said apparatus comprising:
a scanning tunnel defining a first opening at a first end for allowing a container holding an object to enter said scanning tunnel, a second opening at a second end for allowing the container to exit said scanning tunnel, and a longitudinal axis extending between said first end and said second end;
a device configured to move the container in a direction of travel along said longitudinal axis through said scanning tunnel between said first opening and said second opening;
a first x-ray beam having a planar configuration and directed within said scanning tunnel in a first x-ray plane through which the container moves, said first x-ray plane being configured at a first angle relative to said longitudinal axis;
a second x-ray beam having a planar configuration and directed within said scanning tunnel in a second x-ray plane through which the container moves, said second x-ray plane being configured at an angle substantially perpendicular to said longitudinal axis;
a third x-ray beam having a planar configuration and directed within said scanning tunnel in a third x-ray plane through which the container moves, said third x-ray plane being configured at an angle substantially perpendicular to said longitudinal axis; and
a fourth x-ray beam having a planar configuration and directed within said scanning tunnel in a fourth x-ray plane through which the container moves, said fourth x-ray plane being configured at a second angle relative to said longitudinal axis.

2. The apparatus of claim 1, wherein said first angle and said second angle have substantially the same angular measures.

3. The apparatus of claim 1, wherein said first angle has an angular measure in the range of thirty degrees to sixty degrees.

4. The apparatus of claim 3, wherein said first angle has an angular measure of forty-five degrees.

5. The apparatus of claim 3, wherein said second angle has an angular measure in the range of thirty degrees to sixty degrees.

6. The apparatus of claim 5, wherein said second angle has an angular measure of forty-five degrees.

7. The apparatus of claim 1, wherein at least one x-ray beam of said first x-ray beam, said second x-ray beam, said third x-ray beam, and said fourth x-ray beam comprises an x-ray beam having multiple energy levels.

8. The apparatus of claim 1, wherein said first x-ray plane, said second x-ray plane, said third x-ray plane, and said fourth x-ray plane are arranged so that said first x-ray plane is encountered first by the container while moving through said scanning tunnel between said first opening and said second opening.

9. The apparatus of claim 1, wherein said first x-ray plane extends in a direction at least partially toward said second opening of said scanning tunnel.

10. The apparatus of claim 1, wherein said fourth x-ray plane extends in a direction at least partially toward said first opening of said scanning tunnel.
